(19) United States
(12) Patent Application Publication
(10) Pub. No.: US 2018/0142715 A1
(43) Pub. Date: May 24, 2018

(54) Device For Retaining A Component

(71) Applicant: A. Raymond et Cie. SCS, Grenoble (FR)

(72) Inventors: Stefan Schulz, Lörrach (DE); Melanie Anna, Hausen im Wiesental (DE); Virginie Pouzols, Huningue (FR); Julien Friedl, Waldighoffen (FR)

(73) Assignee: A. Raymond et Cie. SCS, Grenoble (FR)

(21) Appl. No.: 15/579,019

(22) PCT Filed: May 31, 2016
(86) PCT No.: PCT/EP2016/000889

§ 371 Date: Dec. 1, 2017

(30) Foreign Application Priority Data
Jun. 1, 2015 (DE) 10 2015 210 063.4
Jun. 1, 2015 (DE) 10 2015 210 092.8

(51) Int. Cl. F16B 5/06; F16B 2/24

(52) U.S. Cl. CPC F16B 5/065; F16B 2/24

(57) ABSTRACT

The invention relates to a device for retaining a component, wherein the device comprises a carrier part and a clip part, the clip part being connected to the carrier part and the clip part including at least one clip surface that is connected to an engaging portion of the clip part, wherein the engaging portion extends in the direction of a central axis away from the carrier part and the clip surface at least largely points toward the carrier part. It is provided that the engaging portion comprises a fulcrum that is located between the clip surface and the carrier part such that the clip surface moves laterally toward the central axis when a portion of the engaging portion, which is located between the fulcrum and the carrier part, is moved laterally away from the central axis.

The invention relates to a device for retaining a component.

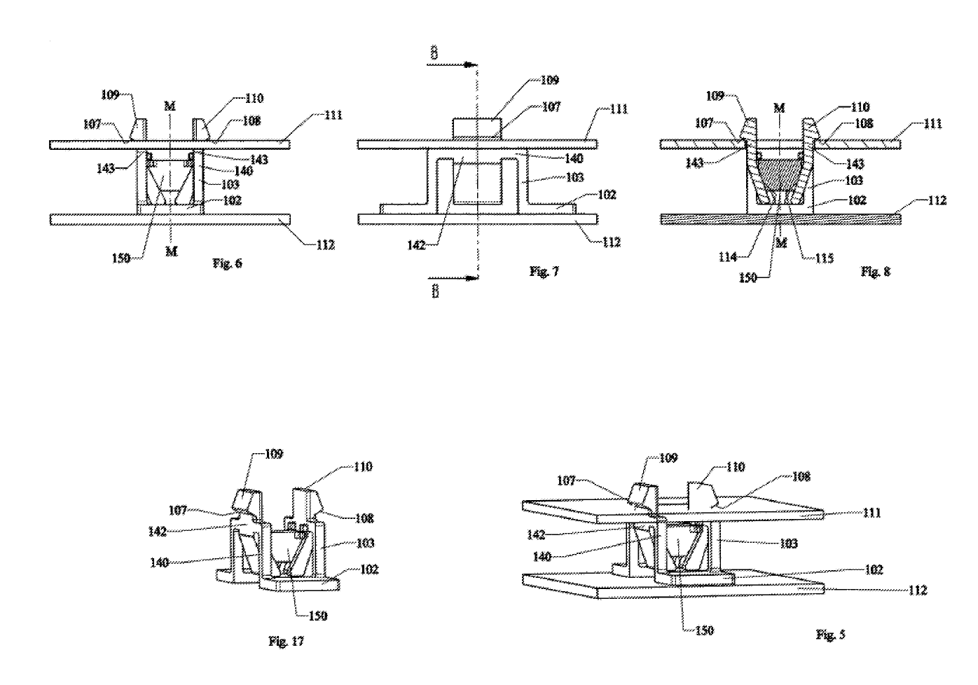

A device for retaining a component is known from US 2011/0209309 A1. The device specified there includes a clip part, which comprises two clip surfaces arranged on opposite sides of a central axis. As shown in FIG. 5 and FIG. 6 of US 2011/0209309 A1, the clip surfaces 23 of the device described therein are designed such that they point in the direction of a base body 20. The device described there can be used to retain the component 19 shown in FIGS. 5 and 6 in relation to the base body 20. To accomplish this, the device described there is connected to a tang 27 on the base body 20. Subsequently, the component 19 is pushed onto the device and the base body 20, at which time the device extends through an opening in component 19. Engaging portions, to which the clip surfaces are connected, are spring-loaded in the position shown in FIG. 4. While being pushed into the opening, the clip surfaces are moved laterally toward the central axis, so that the outer cross-section of the device decreases in the area of the clip surfaces. After having extended through the opening in component 19, the clip surfaces spring back to the position shown in FIGS. 5 and 6, due to the preload of the engaging portions. In this position, they retain the component 19 in relation to the base body 20, such that the component 19 cannot move in a downward direction away from the base body 20 in FIG. 5.

Likewise, a device for retaining the components 9, 40, 41 in relation to a base body 29 is known from US 2013/0183089 A1. The component specified there comprises a carrier part 22 and a clip part that is connected to the carrier part 22. The clip part includes a clip surface 9, which is connected to an engaging portion of the clip part, wherein the engaging portion extends away from the carrier part in the direction of a central axis. The clip surface 9 at least largely points toward the carrier part 22.

In view of the above, the object of the invention is to create a device for fastening a component, which ensures secure retention of the component, but which also provides the option of releasing the retained component.

This problem is solved by the device of claim 1. Advantageous embodiments are represented in the dependent claims and in the following description.

The invention is based on the principle of providing a fulcrum on the engaging portion, so that the clip surface is moved laterally toward the central axis when a portion of the engaging portion is moved away from the central axis. To achieve this, the fulcrum is located in a space on the engaging portion that is between the clip surface and the carrier part.

The lateral movement of the clip surface toward the central axis can be utilized to release the connection to the component that is to be retained. If, for example, the clip part of the device partially extends through an opening in the component, wherein the interaction of the clip surface with the edge of the opening retains the component, it follows that moving the clip surface laterally toward the central axis can cause the release of this connection. Applications of the inventive device are conceivable, in which a particular compact design of the device is crucial. This could result in the slimmest-possible realization of the clip part and the carrier part. At the same time, sufficient space will be available around the sides of the device in the majority of potential applications of the inventive device. The inventive device makes it possible to move a portion of the engaging portion, which is located between the fulcrum and the carrier part, laterally away from the central axis, meaning into the open space surrounding the device, thereby causing a lateral movement of the clip surface toward the central axis. This makes it possible to achieve the advantage of a device with compact design. But advantages are also conceivable for the opposite direction of movement. As the fulcrum causes a lateral movement of the clip surface toward the central axis when a portion of the engaging portion, which is located between the fulcrum and the carrier part, is moved laterally away from the central axis, it also facilitates a lateral movement of the clip surface away from the central axis when a portion of the engaging portion, which is located between the fulcrum and the carrier part, is moved laterally toward the central axis. Such an embodiment is advantageous, for example, if the area, in which the engaging portion is to be moved laterally toward the central axis, is very small and if there is very little space surrounding the device in such an application. In such embodiments, the movement can be reversed, with the effect that a clip surface, which, for example, grips the outside of the component, is swiveled away from the component, thereby releasing it.

In one preferred embodiment, the engaging portion is connected to a torsion bar, which is arranged in a space between the clip surface and the carrier part and which forms the fulcrum of the engaging portion, wherein the torsion bar is a part of the clip part. In a particularly preferred embodiment, the torsion bar longitudinally extends at an angle of greater than 45° and less than 135°, with particular preference given to an angle of essentially 90°, from the point at which it is connected with the engaging portion. The connection point between the torsion bar and the engaging portion is the fulcrum of the engaging portion. On the one hand, the use of a torsion bar makes it easier to pivot the engaging portion. On the other, the use of a torsion portion makes it possible to preload the engaging portion to a normal position. In one particular preferred embodiment, the clip part of the inventive device is manufactured from sheet metal, by die-cutting and then bending portions of the die-cut sheet metal. Providing a torsion bar lends itself to such a manufacturing process of a clip part, as the torsion bar can easily be formed from an appropriately dimensioned sheet metal portion.

In one preferred embodiment, the fulcrum is designed to be moveable in relation to the carrier part in the direction of the central axis. Through the use of deflectors, this movability can be utilized to move the clip surface, which is connected to the engaging portion, laterally toward the central axis or away from the central axis. This provides the option of retaining the component due to the contact of the clip surface with the component, while at the same time providing the option of moving the clip surface in a direction that releases the retained component, by moving the fulcrum in relation to the carrier part.

To achieve this effect, one embodiment of the invention operates with a deflector that is oriented at an angle to the central axis. The deflector is provided on one of the two parts that are movable relative to each other and interacts with a protrusion on the respective other of the two parts that are movable relative to each other. When the two parts are moved relative to each other, the protrusion on the one part glides along the deflector of the respective other part. As the deflector is oriented at an angle to the central axis and therefore at an angle to the direction of the relative movement of the two parts to each other, the gliding of the protrusion along the deflector causes a movement that is perpendicular to the central axis. This movement perpendicular to the central axis can be utilized to cause a lateral movement of the clip surface toward the central axis or away from the central axis.

In a first embodiment, the deflector is included on the engaging portion, specifically in the space between the fulcrum and the carrier part, which means not on the side of the fulcrum on which the clip surface is located. The deflector is oriented at an angle to the central axis and makes contact with a protrusion on the carrier part. This contact with the protrusion on the carrier part occurs at least at the time when the fulcrum is moved relative to the carrier part in the direction of the central axis, in particular in the direction of the central axis toward the carrier part. Therefore, versions of this device are conceivable, in which the deflector initially does not make contact with the protrusion on the carrier part, and where the fulcrum and, consequently, the engaging portion comprising the deflector first must be moved a certain distance in the direction of the central axis toward the carrier part, until the deflector finally makes contact with the protrusion on the carrier part. The movement of the engaging portion in the direction of the central axis then causes the protrusion to glide along the deflector.

In one preferred embodiment, the protrusion on the carrier part is of a rigid design, while the portion of the engaging portion that comprises the deflector is movable within the clip part. Movable embodiments of the engaging portion are understood to include those, in which the engaging portion is moved out of a normal position by applying force against a preload force and in which it returns to the normal position when the manual force is no longer applied. This preload force can be provided by the torsion bar included in the particularly preferred embodiment, for example. The gliding of the protrusion on the carrier part along the deflector on the engaging portion causes the portion of the engaging portion that comprises the deflector to move perpendicularly to the central axis, away from the protrusion. The orientation of the deflector can then be changed in the design to adjust whether a movement of the engaging portion in the direction of the central axis causes this portion of the engaging portion to move laterally toward the central axis or away from the central axis. If the deflector is arranged such that its portion that is closest to the carrier part extends toward the central axis and the portions increasingly distant from the carrier part are increasingly distant from the central axis, the gliding of the protrusion on the carrier part along the deflector, provided the protrusion on the carrier part is rigid and the clip part is moving toward the carrier part, causes the portion of the engaging portion that comprises the deflector to laterally move toward the central axis. However, if the deflector is arranged such that its portion that is closest to the carrier part extends away from the central axis and the portions increasingly distant from the carrier part are increasingly close to the central axis, the gliding of the protrusion on the carrier part along the deflector, provided the protrusion on the carrier part is rigid and the clip part is moving toward the carrier part, causes the portion of the engaging portion that comprises the deflector to laterally move away from the central axis.

Due to the reversed movement via the fulcrum, the interaction between the protrusion and the deflector described in the previous section causes the clip surface to laterally move in the opposite direction, either toward the central axis or away from it.

The inventive principle also can be realized by including the deflector on the carrier portion and arranging it an angle to the central axis. In this embodiment, the deflector makes contact with a protrusion on the engaging portion, which will be referred to as “finger” in the following for easier distinction, but without implying a particular geometric shape of the protrusion to be provided on the engaging portion for the interaction with the deflector on the carrier part. In the embodiment described here, the finger on the engaging portion glides along the deflector on the carrier part when the fulcrum, and thereby the engaging portion, is moved relative to the carrier part in the direction of the central axis, and, in a particularly preferred embodiment, toward the carrier part. If the deflector on the carrier part is of a rigid design and if the portion of the engaging portion that comprises the finger is movable within the clip part, the gliding of the finger on the engaging portion along the deflective axis of the carrier part causes the portion of the engaging portion that includes the finger to yield when the engaging portion is moved relative to the carrier part in the direction of the central axis. Because of this yielding, this portion of the engaging portion can be moved laterally toward the central axis or away from the central axis, depending on the orientation of the deflector on the carrier part. Here again, the movement reversal via the fulcrum means that moving the portion of the engaging portion that comprises the finger perpendicular to the central axis simultaneously causes a movement of the clip surface in the opposite direction.

The two implementations of the inventive principle described previously can be combined. For example, embodiments are conceivable, which include both a deflector on the engaging portion that interacts with a protrusion on the carrier part, and a deflector on the carrier part that interacts with a finger on the engaging portion. The combination of these two effects permits the generation of an effective force from the movement of the engaging portion relative to the carrier part, which moves the clip surface laterally toward the central axis or away from the central axis, while at the same time achieving a compact design, for example, if the respective deflectors are provided on independent, adjacent flat portions of the engaging portion or, respectively, of the carrier part. Providing multiple deflectors reduces the strain on any one deflector.

Also conceivable are embodiments, wherein the protrusion on the carrier part or, respectively, the finger on the engaging portion are designed with a sloping edge, so that the deflector, which is oriented at an angle to the central axis, interacts with the surface on the carrier part or, respectively, on the engaging portion, which also is oriented at an angle to the central axis. This distributes the force to be transmitted across a greater area. A point load on the point where the deflector interacts with the protrusion, or, respectively, the finger, is avoided when the surface of the protrusion, or the surface of the finger, is designed as a sloped surface.

The invention relates to a device for retaining a component. This ability is only accomplished if the inventive device can be connected to a base body and if its design allows it to retain another component in relation to the base body. “Retaining” in this context is understood as preventing the movement of the component in a direction relative to the base body. For example, it is intended to avoid movement of the component of more than a certain, defined distance from the base body. It can be left open in this context whether the inventive device only prevents a movement of the component in one direction relative to the base body, while, for example, permitting the component to move in the opposite direction, toward the base body, or if the device even is able to prevent movements of the component both in a first direction and in the opposite direction relative to the base body.

In a preferred embodiment, described below, it is provided to affix the inventive device on a base body, for example, to glue or weld the device to the base body, and to retain the component to this base body with the device, such that it cannot move away from the base body in one direction.

The ability of the inventive device to retain a component derives from the clip surface and its orientation relative to the carrier part. The inventive device comprises a carrier part and a clip part, wherein the clip part is connected with the carrier part. The clip part comprises a clip surface, which at least largely points toward the carrier part. The object of the clip surface is to retain the component to be retained. The component to be retained comes into contact with the clip surface. As the clip surface at least largely points toward the carrier part, the contact of the component with the clip surface prevents the component from moving farther away from the base body. If the carrier part is connected to the base body, this fundamental design of the inventive design permits the retaining of the component relative to the base body. The exact design of the clip surface can be derived from the type of component that is to be retained. It is expected that particularly good retention will be accomplished if the clip surface is positioned perpendicular to the direction in which the component is to be prevented from moving. This will result in the greatest blocking effect. If the direction in which the component is to be prevented from moving coincides with the central axis, the clip surface is arranged perpendicular to the central axis in one particularly preferred embodiment. However, it is also conceivable that the clip surface is positioned at an angle to the direction in which the component is to be prevented from moving. This can lead to further effects. For example, embodiments are conceivable, wherein the clip surface is inserted into an opening in the component or guided past a side of the component during the attachment of the component to the base body, and that the clip surface snaps back to a normal position after passing an edge of the component due to a preload force acting upon the engaging portion. This snapping back is simplified if the clip surface is arranged at an angle to the direction in which it is intended to prevent the component from moving. Furthermore, the angled design of the clip surface facilitates the negotiation of manufacturing tolerances. If the clip surface is positioned at a 90° angle to the direction in which it is intended to prevent the component from moving, it must be ensured, due to manufacturing tolerances, that the clip surface of the embodiment described here actually is able to pass the edge of the component and to snap back to its normal position. To this end, it must be ensured that the distance between the edge of the component and the base body is great enough for the clip surface to actually snap back to its normal position. In the case of a clip surface designed with a slope, the clip surface glides over a certain area along the edge of the component. This facilitates at least a partial snapping back of the clip surface to a normal position, even if the position of the edge relative to the base body is not perfectly realized.

In a particularly preferred embodiment, a clip surface is still considered to at least largely point toward a carrier part if its surface normal is positioned at an angle of 45° to the central axis of the carrier part.

The clip part is connected to the carrier part. At the same time, the fulcrum that is provided on the engaging portion is movable relative to the carrier part in the direction of the central axis. In one preferred embodiment, this can be accomplished by providing the carrier part and the clip part as independent parts of the inventive device. These two components can then be connected via a snap connection, for example. In a snap connection, a protrusion on one component engages with a protrusion on the other component. This snap connection fixes the first component to the second component with regards to movements in one direction, specifically the direction that led the protrusions to engage with each other. However, relative movement in the opposite direction is still possible. In other embodiments, the clip part and the carrier part are connected via an elastic element. This type of connection also ensures that the clip part cannot move away from the carrier part in a first direction by more than a distance prescribed by the elastic connection, while the elastic connection at the same time permits a movement of the engaging portion relative to the carrier part, specifically in the direction that is opposite to the first direction.

The clip part of the inventive device comprises an engaging portion. The clip surface is connected with this engaging portion. At the same time, the engaging portion extends away from the carrier part in the direction of a central axis. In one particularly preferred embodiment, the central axis is that axis, in the direction of which the inventive device is intended to prevent the component from moving, which is to say, to retain it. In the particularly preferred applications of the inventive device, the component to be retained is moved to a position relative to the base body, in which it is to be retained. In particularly preferred applications, this is accomplished by moving the clip surface and at least that portion of the engaging portion that comprises the clip surface relative to the component; specifically, in a preferred embodiment, it is accomplished by moving them past the component to be retained until the clip surface has passed an edge of the component. In a particularly preferred embodiment, the inventive device is intended to facilitate the movement of the clip surface and the portion of the engaging portion that is connected with it through an opening in the component to be retained, and that the clip surface snaps back to a normal position after it emerges from the opening. It is of particular advantage for these particularly preferred applications if the engaging portion extends away from the carrier portion. This makes it possible to realize the clip part and, in particular, the engaging portion of the clip part in a rather elongated shape, which facilitates their proper insertion into an opening of a component; additionally, or alternatively, the carrier part can be implemented in a rather wide shape to facilitate a good connection of the carrier part with the base body.

The engaging portion extends in the direction of a central axis away from the carrier part. The term “engaging portion” is interpreted broadly in the context of this specification and the claims. The portion of the clip part that is described with this term not only comprises the portion of the clip part, which is connected with the clip surface, but also the portion of the clip part that includes the deflector. The portion of the clip part described with this term may also include a portion extending beyond the deflector in the direction of the carrier part. The requirement on the engaging portion to extend in the direction of the central axis away from the carrier part does not preclude parts of the engaging portion from being realized such that they extend as far as the carrier part or even inside the carrier part, for example inserted through an opening in the carrier part. The engaging portion is to be considered as that part of the clip part, which is deflected from a normal position by the interaction of the deflective portion with the protrusion or, respectively, the finger.

The fulcrum is movable relative to the carrier part in the direction of the central axis. This means that at least that part of the engaging portion, which comprises the fulcrum, is movable relative to the carrier part in the direction of the central axis. In one particularly preferred embodiment, a frame is provided as a part of the clip part, relative to which the engaging portion can swivel around the fulcrum. It is particularly preferred for the frame to be movable relative to the carrier part in the direction of the central axis. As the frame carries the engaging portion, a movement of the frame relative to the carrier part simultaneously causes a movement of the fulcrum and the engaging portion relative to the carrier part. One particularly preferred embodiment includes a guide for the frame, which limits the movement of the frame relative to the carrier part to a movement in the direction of the central axis. This ensures that the movement of the frame, and thereby of the fulcrum and the engaging portion, relative to the carrier part occurs exactly in the direction that facilitates proper interaction of the deflector with the protrusion on the carrier part or, respectively, the finger on the engaging portion. It is particularly preferred for such a guide to be accomplished via a guide surface that is arranged parallel to the central axis. Such a guide surface can be provided on the frame, for example, and can interact with the edge of an opening provided as part of the carrier part. If such an opening in the carrier part is realized as a rectangular opening in one preferred embodiment, a frame realized such that its corresponding portion also includes a rectangular profile over a certain portion of its length can have three or even four (if the opening is arranged as a slot) of its total of four surfaces, which are perpendicular to each other, arranged such that the frame moves along the central axis relative to the carrier part.

Guiding the movement of the clip part relative to the carrier part can also be accomplished via guide surfaces that are arranged with a distance between them. For example, the frame can comprise two lateral surfaces arranged with a distance between them. In such an embodiment, two opposing guide surfaces can be provided on the carrier part, for example, wherein the first guide surface guides the first lateral surface of the frame and the second guide surface guides the second lateral surface of the frame. The contact of the surfaces prevents tilting.

The engaging portion extends away from the carrier portion in the direction of a central axis. In the context of this specification and the claims, the term “central axis” not only describes an axis that extends through the center of mass of the clip part and/or the center of mass of the carrier part. The use of the term “central axis” is only intended to indicate that this axis runs through the interior of the carrier part and/or the clip part in the majority of conceivable embodiments.

A deflector is provided on the engaging portion of the inventive device. The engaging portion of the clip part can be an elongated portion of the clip part, which extends parallel to the central axis in a first portion and extends at an angle to the central axis in another portion. The deflector can be included in this area. The engaging portion also can be a solid element of the clip part, which includes a longitudinal axis that extends parallel to the central axis. In one end portion of such a solid engaging portion, a deflector positioned at an angle to the central axis can be provided by tapering the engaging portion toward that end (reducing its cross-section). In many possible applications of the inventive device, clips are used, which are manufactured by cutting and bending sheet metal. The deflector on the engaging portion therefore can also be realized such that the engaging portion is a strip of sheet metal and the deflector is provided on a tab of the sheet metal strip, which has been bent relative to the sheet metal strip. The deflector can then be realized by one of the narrow lateral surfaces of the appropriately shaped tab.

In the version of the inventive device that was described first, the carrier part comprises a protrusion, which interacts with the deflector on the engaging portion. It is conceivable that the carrier part is designed relatively solid and that it includes a protrusion, for example in the form of an edge or a lip. This edge or lip could delimit an opening in the carrier part, through which the clip part extends partially. This extension of the clip part through the opening of the carrier part can, for example, be used to connect the clip part with the carrier part, for example with a frame of the clip part. If a protrusion is provided on the part of the clip part that extends through the opening of the carrier part, and if that protrusion extends beyond the cross section of the opening in the carrier part and thereby engages with this portion of the carrier part, it will prevent the clip part from being pulled out of the opening of the carrier part. However, the protrusion on the carrier part interacting with the deflector on the engaging portion does not have to be formed by an edge or a lip of a solid component. The protrusion can also be provided as a finger or bar or rib. Furthermore—as mentioned previously—the protrusion can be a surface extending at an angle to the central axis, so that two surfaces extending at angles to the central axis glide along each other when the engaging portion is moved relative to the carrier part in the direction of the central axis.

In the version of the inventive device that is described second, the clip part comprises a protrusion that is described as “finger” for better reference, which interacts with the deflector on the carrier part. It is conceivable that the carrier part is realized relatively solid and that it comprises the deflector, for example adjacent to an opening or as the cause of a recess. The clip part can extend into the opening or, respectively, the recess. The extension of the clip part into the opening on the carrier part can be used, for example, to connect the clip part with the carrier part. If, for example, a protrusion is provided as part of a frame in that portion of the clip part that extends through the opening of the carrier part, and if that protrusion extends beyond the cross section of the opening in the carrier part and thereby engages with this portion of the carrier part, it will prevent the clip part from being pulled out of the opening of the carrier part. The protrusion on the engaging portion interacting with the deflector on the carrier part can be formed as an edge or a lip. The protrusion can also be designed as a finger or bar or rib. Furthermore—as mentioned previously—the protrusion can be a surface extending at an angle to the central axis, so that two surfaces extending at angles to the central axis glide along each other when the engaging portion is moved relative to the carrier part in the direction of the central axis.

In the inventive device, the gliding of the protrusion or, respectively, the finger along the deflector causes a lateral movement of the clip surface, which is connected to the engaging portion, toward the central axis or away from the central axis. A lateral movement of the clip surface toward the central axis is particularly appropriate in those embodiments, in which the inventive device engages with the component to be retained by extending through an opening in that component and in which the clip surface is intended to be moved farther into the area of the opening to release the connection. A lateral movement of the clip surface away from the central axis is particularly appropriate in those embodiments, in which the inventive device engages with the component to be retained by grasping the outside of that component and in which the clip surface is intended to be moved away from the component to release the connection. If the carrier part is arranged underneath the component in these cases and if the central axis extends through the component, the clip surface must be moved laterally away from the central axis to release the connection.

In one preferred embodiment, an opposing surface is provided on the engaging portion, which, together with the clip surfaces, forms a slot to receive the component. This embodiment is preferred if the component not only is to be retained with respect to movement in one direction, but also is required to not move in the opposite direction relative to the base body or, correspondingly, to the carrier part connected to the base body. Providing an opposing surface prevents the movement of the component in the opposite direction.

In one preferred embodiment, the engaging portion is preloaded in a direction that is opposite to the direction of the movement of the clip surface that is caused when the protrusion glides along the deflector while the engaging portion is moved in the direction of the central axis relative to the carrier part. The object of the inventive device is to retain a component. To accomplish this, it is essential to secure the clip surface in a position (the normal position), in which its retaining quality takes effect. At the same time, the object of the invention is to facilitate the release of the connection between component and base body, which the invention accomplishes by taking advantage of the fact that a movement of the engaging portion relative to the carrier part and the interaction of the deflector with the protrusion or, respectively, the finger can be used to cause a lateral movement of the clip surface toward the central axis or away from the central axis, and thereby a movement of the clip surface out of the position, in which it securely retains the component. To avoid compromising the desired secure retention of the component in the normal position of the clip part through this additional function of making the connection releasable, it is provided in one particularly preferred embodiment that the normal position, in which the clip surface properly retains the component, is the default position of the engaging portion. This also means that the movement of the protrusion on the carrier part along the deflector or, correspondingly, the movement of the finger on the engaging portion along the deflector, and the resulting lateral movement of the clip surface toward the central axis or away from the central axis should be conducted against the resistance of a preload. This can impede the release of the connection, which seems acceptable if it also supports the safe retention of the component in the normal position. This preload can be accomplished by connecting the engaging portion with a torsion bar and making the fulcrum of the engaging portion the point of connection with the torsion bar. This preload also can be accomplished by including a rigid part, for example a frame, on the clip part, relative to which the engaging portion can be rotated around the fulcrum. This embodiment can also include a spring between the engaging portion and the rigid part, which preloads the engaging portion into a preferred position (the normal position).

In one preferred embodiment, the clip part comprises a frame, with which the engaging portion is connected such that the engaging portion can be rotated. For example, the frame can comprise a rectangular portion, which includes a rectangular recess. A torsion bar, which is connected with the engaging portion, can be part of the frame, such that the torsion bar can be rotated or swiveled relative to the frame. The frame can then comprise additional brackets, which point away from the rectangular portion at an angle, and through which the frame and, therefore, the clip part are connected with the carrier part. The engaging portion is connected with the frame, such that the portion that is connected to the clip surface is located on the other side of the frame from the portion, on which the deflector is included. The rotating connection of the engaging portion with the frame can facilitate a movement reversal. If the part of the engaging portion that is connected to the deflector is moved laterally away from the central axis by the interaction of the protrusion with the deflector, the part of the engaging portion that is connected to the clip surface is moved laterally toward the central axis. The torsion bar can be used to preload the engaging portion toward the normal position.

In one preferred embodiment, an indentation is located on the deflector on the engaging portion or at the edge of the deflector, in which the protrusion can engage after it has glided along at least a portion of the deflector. This indentation can be used to hold the engaging portion in an instable balance toward a position curved away from its normal position, despite its preload toward the normal position. The indentation can be used in such a way because it can prevent the protrusion from following the preload of the engaging portion and gliding back along the deflector when the force, which caused the movement of the fulcrum relative to the carrier part in the direction of the central axis, is no longer applied. This facilitates holding the clip surface in a plane that is outside of its normal position. This permits the manipulation of the component to be retained relative to the device, for example, pulling away the component or re-installing it. Only after the protrusion is moved out of the indentation through the application of additional force can the protrusion follow the preload of the engaging portion and glide farther along the deflector to the normal position.

In one preferred embodiment, an indentation is located on the deflector on the carrier part or at the edge of the deflector, in which the protrusion (finger) can engage after it has glided at least along a portion of the deflector. This indentation can be used to hold the engaging portion in an instable balance toward a position curved away from its normal position, despite its preload toward the normal position. The indentation can be used in such a way because it can prevent the protrusion (finger) from following the preload of the engaging portion and gliding back along the deflector when the force, which caused the movement of the fulcrum relative to the carrier part in the direction of the central axis, is no longer applied. This facilitates holding the clip surface in a plane that is outside of its normal position. This permits the manipulation of the component to be retained relative to the device, for example, pulling away the component or re-installing it. Only after the protrusion is moved out of the indentation through the application of additional force can the protrusion follow the preload of the engaging portion and glide farther along the deflector to the normal position.

In one preferred embodiment, the inventive clip part comprises a second clip surface. The second clip surface is connected to a second engaging portion of the clip part. The second engaging portion comprises a second fulcrum, which is located between the second clip surface and the carrier part, such that the second clip surface moves laterally toward the central axis when a portion of the second engaging portion, which is arranged between the fulcrum and the carrier part, is moved laterally away from the central axis.

Providing two or more clip surfaces improves the retention of the component. Additionally, providing two or more clip surfaces creates a symmetry of the retention forces and thereby prevents the tilting of the component, which is to be retained, relative to the carrier part and/or relative to the base body. Furthermore, providing two clip surfaces and, thereby, two engaging portions is useful to create a symmetry of forces in those embodiments, in which a preload of the engaging portions toward a normal position is provided.

In one preferred embodiment, the second engaging portion is connected to a second torsion bar, which is arranged between the second clip surface and the carrier part, and which forms the second fulcrum of the second engaging portion, wherein the second torsion bar is a portion of the clip part.

In one preferred embodiment, the second fulcrum is movable relative to the carrier part and movable in the direction of the central axis relative to the carrier part, wherein a deflector is provided on the second engaging portion, wherein the deflector is located in the space between the second fulcrum and the carrier part, and is oriented at an angle to the central axis, wherein the deflector makes contact with a second protrusion on the carrier part and the second protrusion glides along the deflector when the second fulcrum is moved in the direction of the central axis relative to the carrier part, which causes a lateral movement of a portion of the second engaging portion, which is located between the second fulcrum and the deflector, toward the central axis or away from the central axis;

and/or
a deflector is provided on the carrier part, wherein the finger is located on the engaging portion in the space between the second fulcrum and the carrier part, and oriented at an angle to the central axis, wherein the deflector makes contact with a finger on the second engaging portion and the finger glides along the deflector when the second fulcrum is moved in the direction of the central axis relative to the carrier part, which causes a lateral movement of a portion of the second engaging portion, which is located between the second fulcrum and the deflector, toward the central axis or away from the central axis.

In one preferred embodiment, the first engaging portion is held in a normal position by a preload and the second engaging portion is held in a normal position by a preload. In one preferred embodiment, the preload force for the first engaging portion acts in the opposite direction to the preload force for the second engaging portion.

In one preferred embodiment, the clip part is arranged mirror-symmetrically with regards to a plane that comprises the central axis, and/or the carrier part is arranged mirror-symmetrically with regards to a plane that comprises the central axis. The mirror-symmetrical arrangement of the clip part or, respectively, the carrier part simplifies the design of the inventive device. At the same time, the mirror-symmetrical arrangement of the clip part or, respectively, the carrier part makes it possible to provide symmetrical retention forces and preload forces.

In one preferred embodiment, the carrier part comprises a flat mating surface for mounting purposes, in particular to weld or glue the carrier part to a base body.

In one preferred embodiment, the clip surface and the engaging portion are formed as one piece. In one particularly preferred embodiment, the clip surface is a surface of a bent part of the engaging portion.

In one preferred embodiment, the carrier part and/or the clip part are made of metal. In one particularly preferred embodiment, the carrier part and/or the clip part are created by bending an appropriately cut strip of sheet metal. It has been shown that such clips are particularly suited to be used as durable means for retaining components.

The redirection of movement via the fulcrum of the engaging portion that is accomplished by the inventive device also can be used for another preferred embodiment. In this preferred embodiment, the device comprises a wedge, which is located within the clip part, specifically in the space between the fulcrum and the carrier part. The wedge is movable relative to the engaging portion. A deflector is provided on the engaging portion, wherein the deflector is located in the space between the fulcrum and the carrier part, and is oriented at an angle to the central axis. The deflector makes contact with the wedge and the wedge glides along the deflector when the wedge is moved in the direction of the central axis relative to the deflector. This causes a lateral movement of a portion of the engaging portion, which is located between the fulcrum and the deflector, toward the central axis (M) or away from the central axis (M). In this embodiment, the movement therefore is not caused by a relative movement of a part of the clip part relative to the carrier part, but by the movement of a movable element inside the clip part (the wedge). In a preferred embodiment, this wedge is made of ferromagnetic material and can therefore be moved by placing a magnet in close proximity.

The inventive device will be particularly useful to the following applications: attaching insulation material, in particular sheets of insulation material; attaching underbody panels; and/or attaching protective plates or fenders.

In the following, the invention is explained in more detail using drawings of exemplary embodiments of the invention, in which:

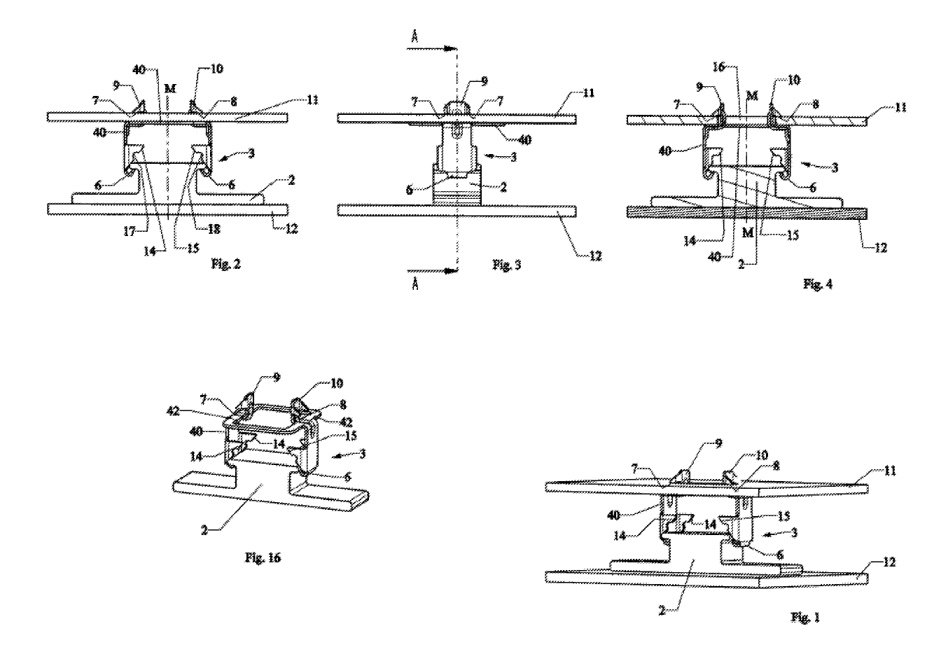

FIG. 1 is a perspective view of a first embodiment of the inventive device, showing how it is attached to a base body and how it retains a component relative to the base body;

FIG. 2 is a first side view of the device according to FIG. 1;

FIG. 3 is a second side view of the device according to FIG. 1; and

FIG. 4 is a sectional view along the line A-A in FIG. 3;

FIG. 5 is a perspective view of a second embodiment of the inventive device, showing how it is attached to a base body and how it retains a component relative to the base body;

FIG. 6 is a first side view of the device according to FIG. 5;

FIG. 7 is a second side view of the device according to FIG. 5; and

FIG. 8 is a sectional view along the line B-B in FIG. 7;

FIG. 9 is a perspective view of a third embodiment of the inventive device, showing how it is attached to a base body and how it retains a component relative to the base body;

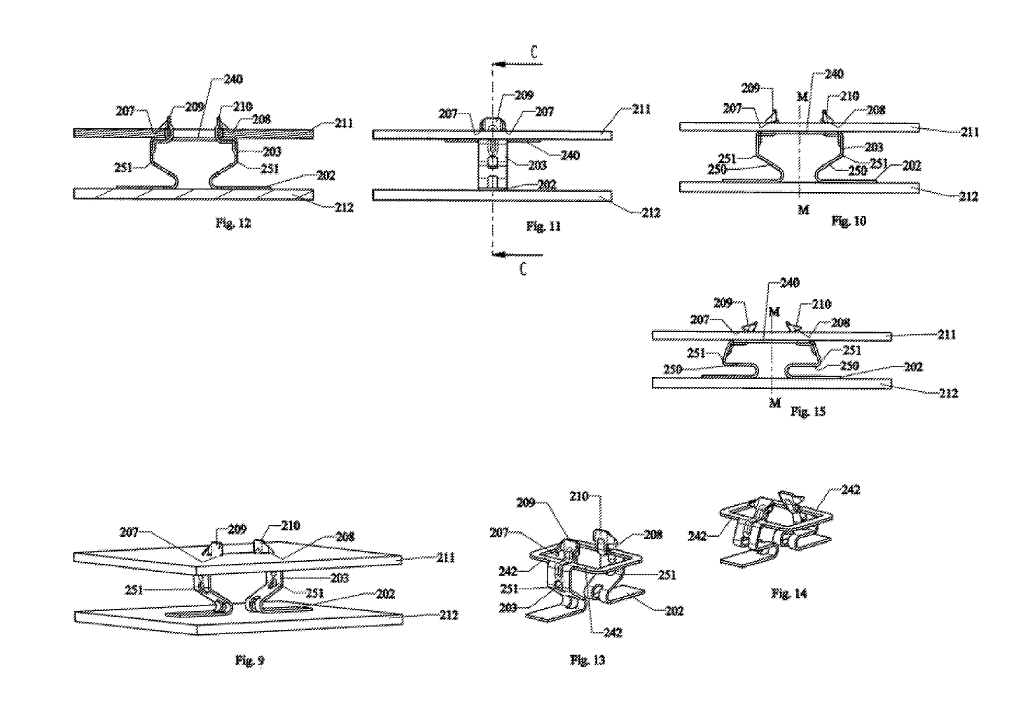

FIG. 10 is a first side view of the device according to FIG. 9;

FIG. 11 is a second side view of the device according to FIG. 9; and

FIG. 12 is a sectional view along the line A-A in FIG. 11;

FIG. 13 is a perspective view of the embodiment according to FIGS. 9 to 12 in a first position;

FIG. 14 is a perspective view of the embodiment according to FIGS. 9 to 12 in a second position;

FIG. 15 is the embodiment according to FIG. 10 in a second position;

FIG. 16 is a perspective view of the embodiment according to FIGS. 1 to 4; and

FIG. 17 is a perspective view of the embodiment according to FIGS. 5 to 8.

FIGS. 1 to 4 and 16 show a first embodiment of the inventive device 1 in its installed state. The device 1 comprises a carrier part 2 and a clip part 3. The clip part 3 is connected with the carrier part 2. This connection is made by the engagement of the protrusions 6 on the clip part 3 with lips on the carrier part 2. This prevents the movement of the clip part 3 along the central axis M away from the carrier part 2, which creates the connection between the clip part 3 and the carrier part 2. At the same time, this connection permits the movement of the clip part 3 in the direction of the central axis M toward the carrier part 2, which is to say, in the opposite direction.

The clip part 3 comprises two first clip surfaces 7 and two second clip surfaces 8. The first clip surfaces 7 are connected to a first engaging portion 9, specifically by the fact that the sheet metal portion forming the first engaging portion comprises bent tabs at its end portion, whose lower side areas include the first clip surfaces 7. This forms the clip surface 7, which at least largely points toward the carrier part 2. The second clip surfaces 8 are connected to a second engaging portion 10 in similar fashion, specifically by being formed by bending tabs on the sheet metal portion forming that engaging portion. The second clip surfaces 8 also largely point toward the carrier part 2.

As FIGS. 1 to 4 show, the first clip surfaces 7 and the second clip surfaces 8 serve to retain a component 11 in relation to a base body 12. As described in the following in more detail, the carrier part 2 is connected with the base body 12. As the clip part 3 is connected with the carrier part 2 and the first clip surface 7 and the second clip surface 8 largely point toward the carrier part 2 and, consequently, the base body 12, they prevent a movement of the component 11 away from the base body 12 along the central axis M and thereby retain the component 11 in relation to the base body 12.

The clip part 3 comprises the first engaging portion 9 and the second engaging portion 10. Additionally, the clip part 3 comprises a frame 40. The first engaging portion 9 is connected with the frame 40 at a fulcrum, specifically via a torsion bar 42 included in the frame. This makes it possible to swivel the engaging portion 9 in relation to the frame while attaching it to the frame. The torsion bar 42 exerts a preload upon the engaging portion 10 in the direction of the normal position shown in FIGS. 1 to 4. The second engaging portion 10 is connected with a torsion bar 42 of the frame 40 at a fulcrum in similar fashion. The first engaging portion 9 and the second engaging portion 10 are sheet metal portions, which were created by bending a larger sheet metal portion, which comprises the frame 40, the first engaging portion 9 and the second engaging portion 10. Bending the material turned clip part 3 into an elastic element. The first engaging portion 9 is preloaded to the left in the view in FIG. 4. Bending it to the right in relation to the frame 40 in the view in FIG. 4 requires a force to overcome the preload of the torsion bar 42. When the first engaging portion 9 is released again, it springs back to the normal position shown in FIG. 4. The second engaging portion 10 is preloaded to the right in the view in FIG. 4. Bending it to the left in relation to the frame 42 in the view in FIG. 4 requires a force to overcome the preload of the torsion bar 42. When the second engaging portion 10 is released again, it springs back to the normal position shown in FIG. 4.

The embodiment illustrated in FIGS. 1 to 4 represents a first version of the inventive device, which comprises two first deflectors 14 on the first engaging portion 9 and two second deflectors 15 on the second engaging portion 10. The deflectors 14 and 15 are oriented at an angle to the central axis M. They are created by bending a tab extending from the respective sheet metal portion forming each engaging portion by 90°. The deflectors 14, 15 are then provided by the surface of the narrow side of the bent tab.

As shown particularly in FIG. 4, the deflectors 14, 15 each make contact with a protrusion on the carrier part 2. The protrusion glides along the respective deflector 14, 15 when the frame 40 and, along with it, the fulcrum and the respective engaging portion 9, 10 are moved toward the carrier part 2 in the direction of the central axis. As the protrusion is rigid, the movement of the engaging portion 9, 10 toward the carrier part 2 causes the lateral movement of the tabs comprising the deflectors 14, 15 and, along with them, of the engaging portions 9, 10 away from the central axis M. During this process, the preload force of the torsion bars 42 is overcome, which holds the engaging portions 9 and 10 in the normal position shown in FIG. 4. The movement reversal by the fulcrums has the effect that the lateral movement of the engaging portions 9 and 10 away from the central axis M causes the clip surfaces 7 and 8, which are connected to the engaging portions 9, 10, to move laterally toward the central axis M.

The clip part 3 can be moved so far toward the carrier part 2 that the resulting movement of the protrusions along the deflectors 14, 15, and the associated lateral movement of the clip surfaces 7, 8 toward the central axis M, extends so far as to cause the clip surfaces 7, 8 to lose their contact with the component 11, which is to be retained, and to be located entirely within the opening 16 in the component 11. This makes it possible to release the connection between the component 11, which is to be retained, and the base body 12. The component 11 can now be removed. This removal of the component 11 is made easier by the provision of the indentations 17, 18 in the deflectors 14, 15, with which the respective protrusions on the carrier part 2 can engage. The indentations 17, 18 are of such a depth that the protrusions cannot glide back along the respective deflectors 14, 15, even if the preload of the engaging portions 9 and 10 attempts to cause such a movement. In this position of an unstable balance, the clip surfaces 7, 8 are held in the compressed position. This facilitates the easy removal and re-attachment of a component 11. After the component 11 has been re-attached, the protrusions can be removed from the indentations 17 and 18 by manually moving the clip part 3, such that the protrusions can glide back along the deflectors 14, 15. This causes the device to return to its normal position shown in FIG. 4.

As visible in FIG. 4, the top of the frame 40 comprises an opposing surface, which, together with the respective clip surface 7 or 8, forms a slot to receive the component 11. This permits the fixed connection of the component 11 with the clip part 3, causing the component 11 to move along with the clip part 3 when the latter is moved.

The figures show that both the clip part 3 and the carrier part 2 are arranged mirror-symmetrically with regards to a plane that comprises the central axis M and which extends perpendicular to the plane of the page in the FIGS. 2 and 4.

The carrier part 2 comprises a flat mating surface. This mating surface facilitates a proper weld between the carrier part 2 and the base body 12.

In the embodiment shown in FIGS. 5 to 8 and 17, components that are equivalent in their function to components in the embodiment described in FIGS. 1 to 4 are labeled with reference numbers that match their equivalents but are raised by a value of 100. In the following, only the functional differences between the two embodiments are described.

Instead of the protrusions 6, which in the embodiment shown in FIGS. 1 to 4 are included on the clip part to connect the clip part 3 with the carrier part 2, the clip part 103 is provided as one piece with the carrier part 102. Of these, the carrier part 102 forms the lower, wider portion of the element, which comprises mating surfaces for the connection with the base body 112. The clip part 103 extends upward from the carrier part 102. Of these, the clip part comprises a frame 140, whose brackets are connected with the carrier part 102 and extend at a right angle to a rectangular portion of the frame 140. The torsion bars 142 are provided as a part of the rectangular portion of the frame 140; their connection with the engaging portions 109, 110 form the fulcrums 143.

The embodiment shown in FIGS. 5 to 8 differs from the embodiment shown in FIGS. 1 to 4 specifically in that the former comprises deflectors 114 and 115, which interact with a wedge 150 of ferromagnetic material at the engaging portions 109, 110. The wedge 150 is located in the space within the clip part 103, specifically in the space between the fulcrum 143 and the carrier part 102. The wedge 150 is movable relative to the engaging portions 109, 110. The deflectors 114, 115 on the engaging portions 109, 110 also are located in the space between the fulcrum 143 and the carrier part 102 and are oriented at an angle to the central axis (M). The deflectors 114, 115 make contact with the wedge 150. If a magnet is arranged underneath the base body 112, the wedge 150 can be moved along the central axis (M) toward the carrier part 102. The wedge 150 then glides along the deflectors 114, 115, which causes a lateral movement of the portion of the engaging portions 109, 110, which are arranged between the fulcrums 143 and the deflectors 114, 115, away from the central axis (M). Due to the movement reversal by the fulcrum 143, this causes the clip surfaces 107, 108 to move laterally toward the central axis M.

In the embodiment shown in FIGS. 9 to 12, components that are equivalent in their function to components in the embodiment described in FIGS. 1 to 4 are labeled with reference numbers that match their equivalents, but are raised by a value of 200. In the following, only the functional differences between the two embodiments are described.

The embodiment shown in FIGS. 9 to 15 differs in the design of the clip part 203 and the carrier part 202. Similar to the embodiment in FIGS. 5 to 8, the clip part 203 and the carrier part 202 are provided as a single piece. Of these, the carrier part 202 forms the lower, wider portion of the element, which comprises mating surfaces for the connection with the base body 212. The clip part 203 extends upward from the carrier part 202. Of these, the clip part comprises a frame 240, whose brackets 250 are connected with the carrier part 202. In the specific embodiment in FIGS. 9 to 12, these brackets are curved (cf. FIGS. 9, 10, 12). The torsion bars 242 are provided as a part of the rectangular portion of the frame 240; their connection with the engaging portions 209, 210 form the fulcrums 243. Due to the curved design of the brackets 250 of the frame 240, a movement of the fulcrums toward the carrier part 202 causes the corner point 251 of the bracket 250 to bend outward (cf. FIG. 13 with FIG. 14, and FIG. 10 with FIG. 15). As the corner point 215 is connected with the clip surfaces 207, 208 as a part of the engaging portion 209, 210, the resulting lateral movement of the corner point 251 away from the central axis M together with the movement reversal of the fulcrum causes the clip surfaces 207, 208 to move laterally toward the central axis M.

1. A device for retaining a component, wherein the device comprises a carrier part and a clip part, the clip part being connected to the carrier part and the clip part including at least one clip surface that is connected to an engaging portion of the clip part, wherein the engaging portion extends in the direction of a central axis away from the carrier part and wherein the clip surface at least largely points toward the carrier part, characterized in that the engaging portion comprises a fulcrum that is located between the clip surface and the carrier part such that the clip surface laterally moves toward the central axis when a portion of the engaging portion, which is arranged between the fulcrum and the carrier part, is moved laterally away from the central axis.

2. The device according to claim 1, characterized in that the engaging portion is connected to a torsion bar, which is located between the clip surface and the carrier part, and which forms the fulcrum of the engaging portion, wherein the torsion bar is a part of the clip part.

3. The device according to claim 1, characterized in that the fulcrum is movable relative to the carrier part and
a deflector is provided on the second engaging portion, wherein the deflector is located in the space between the fulcrum and the carrier part, and is oriented at an angle to the central axis, wherein the deflector makes contact with a protrusion on the carrier part and the protrusion glides along the deflector when the fulcrum is moved in the direction of the central axis relative to the carrier part, which causes a lateral movement of a portion of the engaging portion which is located between the fulcrum and the deflector, toward the central axis or away from the central axis; and/or
a deflector is provided on the carrier part and oriented at an angle to the central axis, wherein the deflector makes contact with a finger on the engaging portion, wherein the finger is located on the engaging portion in the space between the fulcrum and the carrier part, and the finger glides along the deflector when the fulcrum is moved in the direction of the central axis relative to the carrier part, which causes a lateral movement of a portion of the engaging portion, which is located between the fulcrum and the deflector, toward the central axis or away from the central axis.

4. The device according to claim 1, characterized by an opposing surface on the engaging portion, which together with the clip surface forms a slot to receive the component.

5. The device according to claim 1, characterized in that the portion of the engaging portion that comprises the clip surface is preloaded in a direction away from the central axis.

6. The device according to claim 5, characterized in that the engaging portion is part of a spring element.

7. The device according to claim 1, characterized in that an indentation is arranged on the deflector on the engaging portion or at the edge of the deflector, in which the protrusion can engage after it has glided along at least a portion of the deflector.

8. The device according to claim 1, characterized in that the clip part comprises a second clip surface, which is connected to a second engaging portion of the clip part, wherein the second engaging portion extends away from the carrier part in the direction of the central axis and wherein the second clip surface at least largely points toward the carrier part, characterized in that the second engaging portion comprises a second fulcrum, which is located between the second clip surface and the carrier part, such that the second clip surface moves laterally toward the central axis when a portion of the second engaging portion, which is located between the fulcrum and the carrier part, is moved laterally away from the central axis.

9. The device according to claim 8, characterized in that the second engaging portion is connected to a torsion bar, which is located between the second clip surface and the carrier part, and which forms the second fulcrum of the second engaging portion, wherein the torsion bar is a part of the clip part.

10. The device according to claim 8, characterized in that the second fulcrum is movable relative to the carrier part and movable in the direction of the central axis relative to the carrier part, and
a deflector is provided on the second engaging portion, wherein the deflector is located in the space between the second fulcrum and the carrier part, and is oriented at an angle to the central axis, wherein the deflector makes contact with a second protrusion on the carrier part and the second protrusion glides along the deflector when the second fulcrum is moved in the direction of the central axis relative to the carrier part, which causes a lateral movement of a portion of the second engaging portion, which is located between the second fulcrum and the deflector, toward the central axis or away from the central axis; and/or
a deflector is provided on the carrier part, wherein the finger is located on the engaging portion in the space between the second fulcrum and the carrier part and oriented at an angle to the central axis, wherein the deflector makes contact with a finger on the second engaging portion, and the finger glides along the deflector when the second fulcrum is moved in the direction of the central axis relative to the carrier part, which causes a lateral movement of a portion of the second engaging portion, which is located between the second fulcrum and the deflector, toward the central axis or away from the central axis.

11. The device according to claim 1, characterized in that the clip part is arranged mirror-symmetrically with regards to a plane that comprises the central axis, and/or that the carrier part is arranged mirror-symmetrically with regards to a plane that comprises the central axis.

12. The device according to claim 1, characterized in that the carrier part comprises a flat mating surface for mounting purposes, in particular to weld the carrier part to a base body.

13. The device according to claim 1, characterized in that the clip surface and the engaging portion are made of a single piece.

14. The device according to claim 1, characterized in that the carrier part and/or the clip part are made of metal.

15. The device according to claim 1, characterized by a wedge, which is located within the clip part, specifically in the space between the fulcrum and the carrier part and which is movable relative to the engaging portion, wherein
a deflector is provided on the engaging portion, wherein the deflector is located in the space between the fulcrum and the carrier part, and is oriented at an angle to the central axis wherein the deflector makes contact with the wedge and the wedge glides along the deflector when the wedge is moved in the direction of the central axis relative to the deflector, which causes a lateral movement of a portion of the engaging portion, which is located between the fulcrum and the deflector, toward the central axis or away from the central axis.

16. The device according to claim 15, characterized in that the wedge is made of ferromagnetic material.

17. A device for retaining a component, wherein the device comprises a carrier part and a clip part, the clip part being connected to the carrier part and the clip part including at least one clip surface that is connected to an engaging portion of the clip part, wherein the engaging portion extends in the direction of a central axis away from the carrier part and wherein the clip surface at least largely points toward the carrier part, characterized in that the engaging portion comprises a fulcrum that is located between the clip surface and the carrier part such that the clip surface laterally moves toward the central axis when a portion of the engaging portion, which is arranged between the fulcrum and the carrier part, is moved laterally away from the central axis, the engaging portion being connected to a torsion bar located between the clip surface and the carrier part, and which forms the fulcrum of the engaging portion.

18. The device according to claim 17, wherein the torsion part is part of the clip part.

19. The device according to claim 17, characterized in that the fulcrum is movable relative to the carrier part and
a deflector is provided on the second engaging portion, wherein the deflector is located in the space between the fulcrum and the carrier part, and is oriented at an angle to the central axis, wherein the deflector makes contact with a protrusion on the carrier part and the protrusion glides along the deflector when the fulcrum is moved in the direction of the central axis relative to the carrier part, which causes a lateral movement of a portion of the engaging portion, which is located between the fulcrum and the deflector, toward the central axis or away from the central axis; and/or
a deflector is provided on the carrier part and oriented at an angle to the central axis, wherein the deflector makes contact with a finger on the engaging portion, wherein the finger is located on the engaging portion in the space between the fulcrum and the carrier part, and the finger glides along the deflector when the fulcrum is moved in the direction of the central axis relative to the carrier part, which causes a lateral movement of a portion of the engaging portion, which is located between the fulcrum and the deflector, toward the central axis or away from the central axis.

20. The device according to claim 17, characterized by an opposing surface on the engaging portion, which together with the clip surface forms a slot to receive the component.
